(19) United States
(12) Patent Application Publication
(10) Pub. No.: US 2001/0003615 A1
(43) Pub. Date: Jun. 14, 2001

(54) MICA TAPE SPLICE AND METHOD OF FORMING THE SAME

(76) Inventor: MIKE LESTER, BURTON, OH (US)

Correspondence Address: PEARNE & GORDON LLP, 526 SUPERIOR AVENUE EAST, SUITE 1200, CLEVELAND, OH, 44114-1484, US

(21) Appl. No.: 09/025,913

(22) Filed: Feb. 19, 1998

(51) Int. Cl. B32B 5/16; B32B 7/12; B32B 15/04

(52) U.S. Cl. 428/324; 428/354

(57) ABSTRACT

A splice and a method of making the same. The splice is formed to join together first and second pieces of mica tape having a mica layer bonded to a first surface of a carrier layer. The mica layer from a portion of the first piece is removed so as to expose the first surface of the carrier layer. A thermoplastic film is disposed on the exposed first surface of the carrier layer of the first piece. A second surface of the carrier layer of the second piece is disposed on the bonding film so as to form an overlap area of the first and second pieces. Pressure and heat are applied to the overlap area to form the splice therein.

### BACKGROUND OF THE INVENTION

This invention relates to mica tape and in particular to a splice for joining together lengths of mica tape.

Mica tape is typically used to insulate electric conductors in applications where the conductors may generate or be exposed to high temperatures. Conventionally, mica tape is very thin, having a thickness between 3 mils (0.003 inches) and 5 mils (0.005 inches), and is formed by bonding a layer of mica to a carrier such as an open-weave fiberglass fabric. This construction provides the mica tape with flexibility and good tensile strength.

A manufacturer of mica tape often produces mica tape in large mill rolls having a width between three and four feet. The manufacturer or an intermediate processor cuts the mica tape to a narrower width and winds the mica tape onto narrow rolls or traverse spools. Often, the manufacturer or the intermediate processor is required to join together pieces of mica tape to meet a particular customer's needs.

Conventionally, pieces of mica tape are joined together using a butt splice, wherein ends of the pieces are butted together to form a seam, and adhesive tape is wrapped around the seam. Typically, the adhesive tape is disposed along 3-4 inches of the length of the joined-together pieces, thereby making the butt splice 3-4 inches long. In addition, the wrapped adhesive tape is typically 3-5 mils thick, thereby making the butt splice 3-5 mils thicker than the rest of the joined-together pieces. Thus, the butt splice extends along a substantial portion of the joined-together pieces and substantially increases the thickness of the joined-together pieces. As a result, the butt splice may produce lumps when the joined-together pieces are wrapped around a spool or an electrical conductor, which is undesirable. Moreover, the butt splice is typically weaker than the rest of the joined-together pieces.

Based upon the foregoing, there is a need in the art for a splice for joining together mica tape and a method of making the same, wherein the splice is strong and does not substantially increase the thickness of the mica tape at the splice. The present invention is directed to such a splice and a method of making the same.

### SUMMARY OF THE INVENTION

It therefore would be desirable, and is an advantage of the present invention, to provide a method of forming a length of mica tape. Pursuant to the method, first and second pieces of mica tape are selected. The mica tape has a mica layer and a carrier layer. The carrier layer has opposing first and second surfaces. The first surface is bonded to the mica layer. The mica layer is removed from a portion of the first piece so as to expose the first surface of the carrier layer. A bonding film is disposed on the exposed first surface of the carrier layer of the first piece. The second surface of the carrier layer of the second piece is disposed on the bonding film so as to form an overlap area of the first and second pieces. In one embodiment, a treatment pressure is applied to the overlap area. In another embodiment, the bonding film is a thermoplastic film and the overlap area is heated to a treatment temperature so as to soften the thermoplastic film.

Also provided in accordance with the present invention is a length of mica tape comprised of first and second pieces of mica tape. The mica tape has a mica layer and a carrier layer. The carrier layer has opposing first and second surfaces. The first surface is bonded to the mica layer. A thermoplastic film is disposed between the carrier layers of the first and second pieces of mica tape. The thermoplastic film is comprised of a terpolymer of tetrafluorethylene, hexafluoropropylene, and vinylidene fluoride.

### BRIEF DESCRIPTION OF THE DRAWINGS

The features, aspects, and advantages of the present invention will become better understood with regard to the following description, appended claims, and accompanying drawings where:

FIG. 1 shows a schematic view of portions of first and second pieces of mica tape;

FIG. 2 shows a schematic view of a portion of a mica layer being removed from the first piece;

FIG. 3 shows a schematic view of the first piece with the mica layer removed so as to expose a carrier layer;

FIG. 4 shows a schematic view of the second piece spaced above a bonding film disposed on the exposed carrier layer of the first piece;

FIG. 5 shows a schematic side view of an overlap area of the first and second pieces in a seeming device; and

FIG. 6 shows a schematic side view of the first and second pieces joined together by a splice in the overlap area.

### DETAILED DESCRIPTION OF THE PREFERRED EMBODIMENTS

It should be noted that in the detailed description which follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

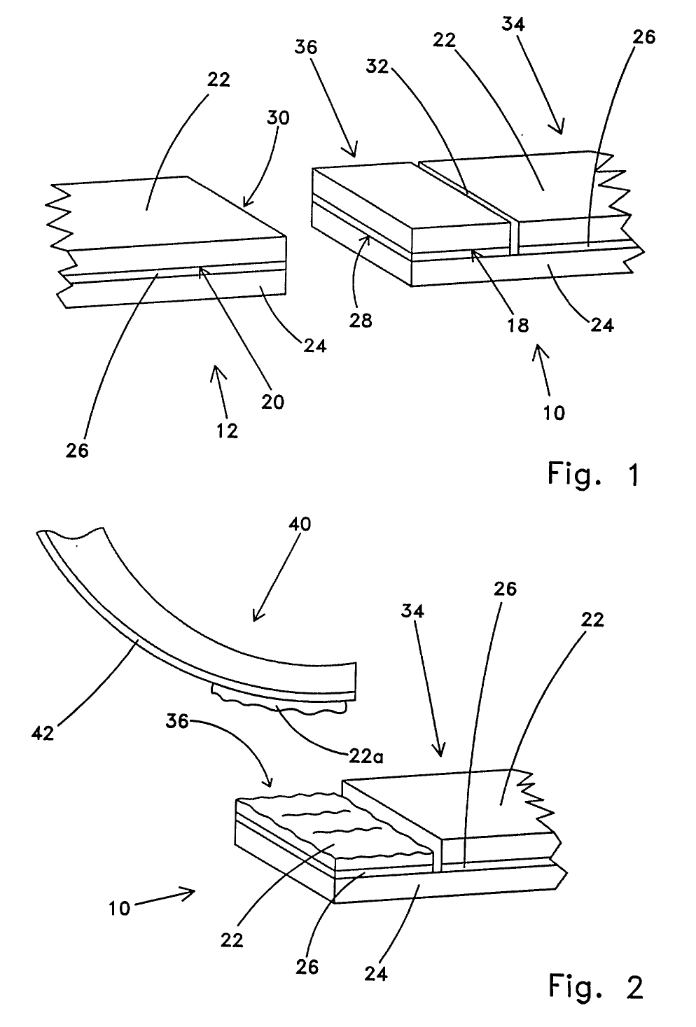

Referring now to FIG. 1, there is schematically shown first and second pieces 10, 12 of mica tape that are to be joined together at a splice 14 (shown in FIG. 6) to form an elongated piece 16 (shown in FIG. 6) of mica tape. The elongated piece 16 of mica tape may be used as an insulator for electric conductors.

The first piece 10 has opposing side edges 18, and the second piece 12 has opposing side edges 20. The first and second pieces 10, 12 have substantially the same width and the same thickness. End users of mica tape commonly request widths between 0.125 inches and 2.0 inches. Accordingly, for purpose of example, but without limitation, the first and second pieces 10, 12 will be presumed to have a width between 0.125 inches and 2.0 inches. Each of the first and second pieces 10, 12 may have any length.

The mica tape includes a mica layer 22, a carrier layer 24 and a binder 26. The carrier layer 24 has a first surface 24a and a second surface 24b. The first surface 24a of the carrier layer 24 is joined to the mica layer 22 by the binder 26.

An example of mica tape suitable for the present invention is sold under the name GEMAX 77635 Mica Cable Tape (the “GEMAX Tape”) by Insulating Materials Incorporated (“IMI”) of Schenectady, N.Y., which is a subsidiary of Von Roll Isola. The GEMAX Tape has an average thickness of 4.5 mils (0.114 millimeters), a weight of 0.235 lb/yd² (127 g/m²), and an average tensile strength of 90 lb/in (157 N/cm). The GEMAX Tape is comprised of calcined muscovite mica paper bonded to woven fiberglass fabric by a silicone resin.

Another example of mica tape suitable for the present invention is sold under the name CABLOSAM ART. 366.22-80 Mica Cable Tape (the “CABLOSAM Tape”) by IMI. The CABLOSAM Tape has an average thickness of 3.0 mils (0.075 millimeters), a weight of 0.160 lb/yd² (87 g/m²), and an average tensile strength of 45 lb/in (80 N/cm). The CABLOSAM Tape is comprised of Phlogopite Samica paper bonded to woven fiberglass fabric by a silicone resin.

For purpose of example and without limitation, the mica tape of the first and second pieces 10, 12 will be assumed to be the GEMAX Tape. With this composition, the first and second pieces 10, 12 each have an average thickness of 4.5 mils. In addition, the mica layer 22 is comprised of calcined muscovite mica paper, the carrier layer 24 is comprised of woven fiberglass fabric, and the binder 26 is a silicone resin.

The splice 14 for joining together the first and second pieces 10, 12 of mica tape is formed by first cutting the first and second pieces 10, 12 to provide the first and second pieces 10, 12 with ends 28, 30. As shown in FIG. 1, the first piece 10 is preferably cut such that the end 28 of the first piece 10 is disposed substantially perpendicular to the side edges 18. Similarly, the second piece 12 is preferably cut such that the end 30 is disposed substantially perpendicular to the side edges 20.

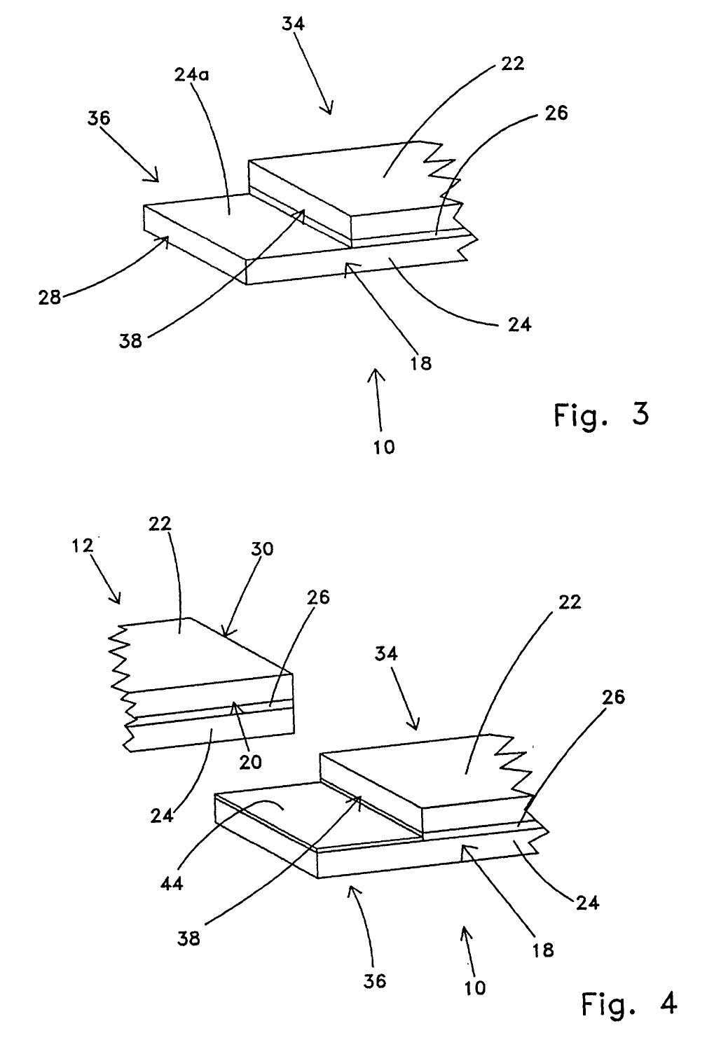

A cut 32 is made through the mica layer 22 and the binder 26 of the first piece 10 at a selected distance from the end 28 of the first piece 10 so as to divide the first portion 10 into a main region 34 and a splice region 36. The cut 32 is made so as to form an end edge 38 (shown in FIG. 3) in the mica layer 22 of the main region 34 that is complementary to the end 30 of the second piece 12, i.e., the end edge 38 can contiguously abut the end 30 when the side edges 18 of the first piece 10 are collinear with the side edges 20 of the second piece 12. Since the end 30 is disposed substantially perpendicular to the side edges 20, the cut 32 is made substantially perpendicular to the side edges 18.

The splice region 36 has a length that extends from the end edge 38 of the mica layer 22 in the main region 34 to the end 28 of the first piece 10. Preferably, the length of the splice region 36 is from about 0.10 inches to about 5.0 inches. More preferably, the length is from about 0.25 inches to about 2.0 inches, and more preferably from about 0.5 inches to about 1.0 inch. Still more preferably, the length is about 0.5 inches.

Referring now to FIG. 2, the mica layer 22 and the binder 26 in the splice region 36 are stripped off the first surface 24a of the carrier layer 24. Preferably, the mica layer 22 and the binder 26 are stripped away using a stripping tape 40 having a layer 42 comprised of a very aggressive adhesive, such as a rubber-based industrial adhesive. A portion of the layer 42 is placed on the mica layer 22 so that the mica layer 22 adheres thereto. The layer 42 is then pulled away to remove a portion 22a of the mica layer 22. This process is repeated with different portions of the layer 42 until substantially all of the mica layer 22 and the binder 26 are removed. Once the mica layer 22 and the binder 26 are removed, the first surface 24a of the carrier layer 24 is exposed in the splice region 36, as shown in FIG. 3.

Referring now to FIG. 4, a bonding film 44 comprised of thermoplastic film is disposed on the exposed first surface 24a of the carrier layer 24 of the splice region 36. Any thermoplastic film may be used for the bonding film 44. Preferably, however, one of the following types of thermoplastic film is used as the bonding film 44: (i) polyethylene, (ii) thermoplastic polyester, such as polyethylene terephthalate (PET), and (iii) fluorocarbon. These types of thermoplastic film are preferred because they have good dielectric properties and good resistance to chemicals. Having good dielectric properties is important because the elongated piece 16 of mica tape may be used as an insulator.

A fluorocarbon film is especially suitable for use as the bonding film 44 because fluorocarbon films have good thermal and chemical resistance, a low dissipation factor, and a low dielectric constant. Examples of suitable fluorocarbon films include: (i) a polytetrafluoroethylene (PTFE) film, (ii) a perfluoroalkoxy (PFA) resin film, (iii) a fluorinated ethylene propylene (FEP) film, and (iv) a terpolymer of tetrafluorethylene, hexafluoropropylene, and vinylidene fluoride (a “THV terpolymer”).

A THV terploymer is most preferred for use as the bonding film 44. As with the other fluorocarbon films, a THV terpolymer has good thermal and chemical resistance, a low dissipation factor, and a low dielectric constant. A THV terpolymer also has good adhesive and elastomeric properties, which will make the splice 14 strong and flexible. In addition, a THV terpolymer has a moderately low melt point compared to other thermoplastics, which permits the splice 14 to be made quickly and with less sophisticated heating equipment. Moreover, when a THV terpolymer is completely degraded under extreme temperatures, no conductive residue is left to provide an electrical path to ground.

A suitable THV terpolymer that may used for the bonding film 44 is sold under the name FLUOROLIN film THV-830 by Dewal Industries, Inc. of Saunderstown, R.I. The FLUOROLIN film THV-830 has a tensile strength of 2,500-4,000 PSI, an elongation of 400-500%, a dielectric strength of 1,300-4,000 Volts/Mil, a specific gravity of 1.98-2.01, and a melting point of 356° F. (180° C.). Other THV terpolymers are available from companies such as the 3M Company. The FLUOROLIN film THV-830 is provided in rolls as a dry film, and is available in a plurality of thicknesses, ranging between 0.5 mils and 20 mils, in increments of 0.1 mil.

In accordance with the preferred embodiment of the invention, a dry film of THV terpolymer is used as the bonding layer 44. Preferably, the bonding layer 44 has a thickness from about 0.5 mils to about 5 mils, more preferably from about 1.0 mil to about 4 mils, and still more preferably from about 1.5 mils to about 2.5 mils. Still more preferably, the bonding 44 layer has a thickness of about 2 mils.

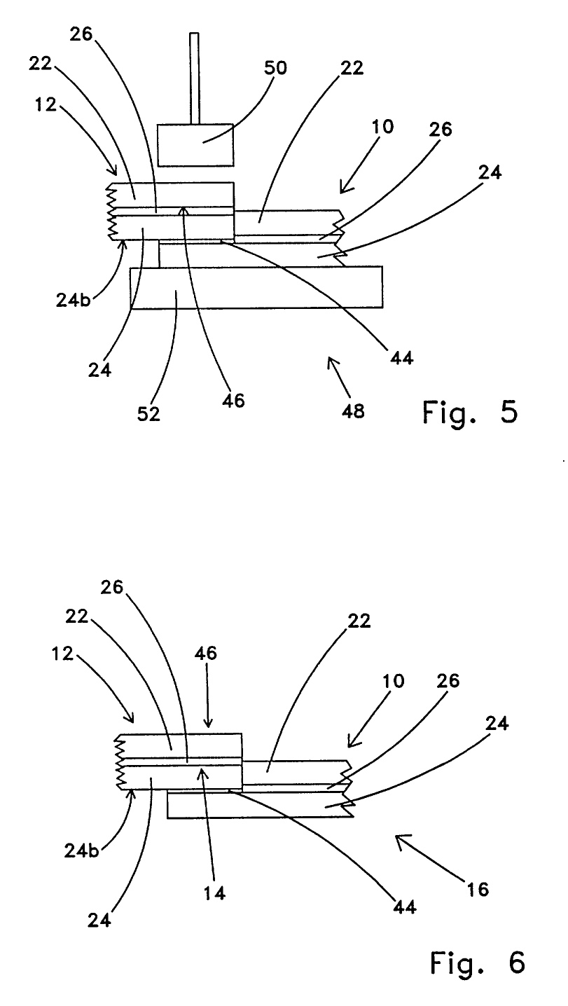

The bonding layer 44 is cut to match the splice region 36 and is deposited on the first surface 24a of the carrier layer 24 of the splice region 36 so as to be aligned therewith. The second surface 24b of the carrier layer 24 of the second piece 12 is then placed over the bonding layer 44. The second piece 12 is positioned such that the end 30 of the second piece 12 contiguously abuts the end edge 38 of the mica layer 22 in the main region 34 of the first piece 10, and such that the side edges 18 of the first piece 10 are collinear with the side edges 20 of the second piece 12. This positioning of the first and second pieces 10, 12 forms an overlap area 46 (shown in FIGS. 5, 6) of the first and second pieces 10, 12.

Referring now to FIG. 5, a seeming process is performed on the overlap area 46 in a seeming device 48. The seeming device 48 includes an upper bar 50 disposed above a stationary lower plate 52. Preferably, the upper bar 50 has substantially the same shape and size as the overlap area 46. The overlap area 46 is disposed between the upper bar 50 and the lower plate 52 when the upper bar 50 is in an upper position (shown in FIG. 5). The upper bar 50 is vertically movable between the upper position, wherein the upper bar 50 is spaced from the overlap area 46 and the lower plate 52, and a lower position, wherein the upper bar 50 presses the overlap area 46 against the lower plate 52. When the upper bar 50 is in the lower position, the upper bar 50 exerts a treatment pressure on the overlap area 46.

During the seeming process, the upper bar 50 is moved to the lower position so as to exert the treatment pressure on the overlap area 46. The upper bar 50 is heated to raise the temperature of the overlap area 46 to an elevated treatment temperature. The treatment pressure and the treatment temperature are maintained for a treatment period of time.

Preferably, the treatment temperature is from about 400° F. to about 600° F., more preferably from about 500° F. to about 600° F., and still more preferably from about 500° F. to about 550° F. Still more preferably, the treatment temperature is about 530° F. The treatment pressure exerted by the upper bar 50 is preferably from about 5 psi to about 40 psi, more preferably from about 10 psi to about 30 psi, and still more preferably from about 14 psi to about 20 psi. Still more preferably, the treatment pressure is about 14 psi. The treatment period is preferably from about 10 seconds to about 2 minutes, more preferably from about 20 seconds to about 60 seconds, and still more preferably from about 30 seconds to about 35 seconds. Still more preferably, the treatment period is about 30 seconds. In summary, during the seeming process, the overlap area is preferably heated to a temperature of about 530° F. and preferably subjected to a pressure of about 14 psi for preferably about 30 seconds.

During the seeming process, the bonding film 44 softens and fuses together the carrier layers 24 of the first and second pieces 10, 12 in the overlap area 46. After the treatment period of time has expired, the overlap area 46 is allowed to cool for at least 15 seconds. The upper bar 50 is then moved to the upper position and the overlap area 46 is removed from the seeming device 48. The cooling of the overlap area 46 causes the bonding film 44 to harden and thereby fixedly secure together the carrier layers 24 of the first and second pieces 10, 12. At this point, the formation of the splice 14 in the overlap area 46 is complete.

Referring now to FIG. 6, the first and second pieces 10, 12 of mica tape are shown joined together by the splice 14 so as to form the elongated piece 16 of mica tape. The splice 14 is about 0.5 inches long and has an average thickness in a range from about 5.5 mils to about 6.0 mils. As set forth above, the average thickness of the mica tape is about 4.5 mils. Thus, the splice 14 is between 1.0 mil and 1.5 mils thicker than the rest of the elongated piece 16.

It should be appreciated that the splice 14 provides numerous benefits over conventional splices. The splice 14 is stronger than prior art splices. In one comparison test, the splice 14 was tested against a butt splice that joined together substantially similar pieces of the same mica tape. The results of the comparison test showed the splice 14 to have almost double the tensile strength of the butt splice.

In addition to being stronger than conventional splices, the splice 14 is shorter than conventional splices, having a length of only 0.5 inches, as compared to a length of 3-4 inches for a conventional butt splice. Moreover, the splice 14 is thinner than conventional splices. The splice 14 only increases the thickness of mica tape by 1.0 mil to 1.5 mils, whereas a conventional butt splice increases the thickness of mica tape by 3 mils to 5 mils.

It should be understood that the present invention is not limited to the preferred embodiments shown and described herein, but covers and includes any and all modifications thereof which fall within the purview of the present invention. For example, the present invention can be practiced with any type of mica tape. In addition, it is contemplated that the materials disclosed for use as the bonding film 44 of the present invention could be replaced by materials having similar structural, chemical and thermal features without departing from the scope of the invention. Therefore, the specific materials disclosed herein are merely provided to illustrate and describe the preferred embodiments of the present invention presently contemplated by the inventor, and are not intended to limit the scope of the present invention, which is defined by the claims appended hereto.

What is claimed is:

1. A method of making a length of mica tape comprising the steps of:
selecting first and second pieces of mica tape having a mica layer and a carrier layer, said carrier layer having opposing first and second surfaces, said first surface being bonded to the mica layer;
removing the mica layer from a portion of the first piece so as to expose the first surface of the carrier layer;
disposing a bonding film on the exposed first surface of the carrier layer of the first piece;
placing the second surface of the carrier layer of the second piece on the bonding film so as to form an overlap area of the first and second pieces; and
applying a treatment pressure to the overlap area.

2. The method of claim 1, wherein the treatment pressure is within the range from about 5 psi to about 40 psi.

3. The method of claim 2, wherein the treatment pressure is about 14 psi.

4. The method of claim 3, wherein the step of applying pressure is performed for a treatment period of from about 10 seconds to about 2 minutes.

5. The method of claim 4, wherein the treatment period is about 30 seconds.

6. The method of claim 5, further comprising the step of heating the overlap area to about 530° F. during the treatment period.

7. The method of claim 1, wherein the bonding film is comprised of a thermoplastic film.

8. The length of mica tape produced by the method of claim 1.

9. A method of making a length of mica tape comprising the steps of:
selecting first and second pieces of mica tape having a mica layer and a carrier layer, said carrier layer having opposing first and second surfaces, said first surface being bonded to the mica layer;
removing the mica layer from a portion of the first piece so as to expose the first surface of the carrier layer;
disposing a thermoplastic film on the exposed first surface of the carrier layer of the first piece;
placing the second surface of the carrier layer of the second piece on the bonding film so as to form an overlap area of the first and second pieces; and
heating the overlap area to a treatment temperature so as to soften the thermoplastic film.

10. The method of claim 9, wherein the treatment temperature is within the range from about 400° F. to about 600° F.

11. The method of claim 10, wherein the treatment temperature is about 530° F.

12. The method of claim 11, wherein the heating step is performed for a treatment period of from about 10 seconds to about 2 minutes.

13. The method of claim 12, wherein the treatment period is about 30 seconds.

14. The method of claim 13, further comprising the step of applying a pressure of about 14 psi on the overlap area during the treatment period.

15. The method of claim 9, wherein the thermoplastic film is a fluorocarbon.

16. The method of claim 15, wherein the fluorocarbon is a terpolymer of tetrafluorethylene, hexafluoropropylene, and vinylidene fluoride.

17. The method of claim 9 further comprising the step of cooling the overlap area.

18. The length of mica tape formed by the method of claim 9.

19. A length of mica tape comprising:
first and second pieces of mica tape having a mica layer and a carrier layer, said carrier layer having opposing first and second surfaces, said first surface being bonded to the mica layer; and
a thermoplastic film disposed between the carrier layers of the first and second pieces of mica tape, said thermoplastic film being comprised of a terpolymer of tetrafluorethylene, hexafluoropropylene, and vinylidene fluoride.

20. The length of mica tape of claim 19, wherein the mica layer from a portion of the first piece has been removed to expose the first surface of the carrier layer; and
wherein the thermoplastic film is disposed between the second surface of the carrier layer of the second piece and the exposed first surface of the carrier layer of the first piece.
